(19) United States
(12) Patent Application Publication
(10) Pub. No.: US 2013/0142181 A1
(43) Pub. Date: Jun. 6, 2013

(54) APPARATUS AND METHOD OF OPERATION FOR A REMOTE CONTROL SYSTEM

(71) Applicants: Saumil Makim, Algonquin, IL (US); Samir Sangani, Hanover Park, IL (US); Ashok Hirpara, Carol Stream, IL (US); John Roberts, Chicago, IL (US); Ravi Mazumdar, Naperville, IL (US); Edward Zylka, Lake Forest, IL (US); Jean Michel Chardon, Toronto (CA); Scott Harrington, Toronto (CA); Joseph Battelle, Est Palo Alto, CA (US); Kevin Simon, Mountain View, CA (US); Glen M. Harris, Auckland (NZ); Justin M. Henry, Mississauga (CA)

(72) Inventors: Saumil Makim, Algonquin, IL (US); Samir Sangani, Hanover Park, IL (US); Ashok Hirpara, Carol Stream, IL (US); John Roberts, Chicago, IL (US); Ravi Mazumdar, Naperville, IL (US); Edward Zylka, Lake Forest, IL (US); Jean Michel Chardon, Toronto (CA); Scott Harrington, Toronto (CA); Joseph Battelle, Est Palo Alto, CA (US); Kevin Simon, Mountain View, CA (US); Glen M. Harris, Auckland (NZ); Justin M. Henry, Mississauga (CA)

(73) Assignee: LOGITECH EUROPE S.A.

(21) Appl. No.: 12/993,248

(22) PCT Filed: Mar. 24, 2010
(86) PCT No.: PCT/US10/28546

§ 371 Date: Jan. 3, 2012

Related U.S. Application Data
(60) Provisional application No. 61/210,896, filed on Mar. 24, 2009.

(51) Int. Cl. H04L 29/02

(52) U.S. Cl. CPC H04L 29/02
USPC 370/338; 370/476; 370/310

(57) ABSTRACT

A remote control system includes a first network configured for communication via a first format. The first network includes a router configured to receive packetized remote control codes transmitted to the router in the first format. The remote control system further includes a second network configured for communication via a set of second formats. The second network includes a translator communicatively coupled to the router via a network link The translator is configured to receive the packetized remote control codes from the router in the first format and translate the remote control codes from the first format to a set of second formats. The second network further includes a blaster communicatively coupled to the translator. The blaster is configured to received the packetized remote control codes in the set of second formats and transmit the packetized remote control codes in the set of second formats to a set of consumer-electronic devices.

### CROSS-REFERENCES TO RELATED APPLICATIONS

This application claims the benefit of, and priority to, U.S. Provisional Patent Application No. 61/210,896, filed Mar. 24, 2009, of Saumil Makim et al., titled “IR Device Controller Apparatus,” and is a Continuation-In-Part Application of U.S. patent application Ser. No. 11/390,916, filed Mar. 27, 2006, of Glen M. Harris, titled “Interface Device and Method for Networking Legacy Consumer Electronic Devices,” which claims the benefit of, and priority to, U.S. Provisional Patent Application No. 60/666,789, filed Mar. 30, 2005, of Glen M. Harris, titled “Interface Device and Method for Networking Legacy Consumer Electronic Devices,” each of which is incorporated by reference herein in its entirety for all purposes.

### BACKGROUND OF THE INVENTION

The present invention relates to a remote control system for controlling a set of consumer-electronic devices. More specifically, specific embodiments of the present invention relate to a remote-control system configured to receive remote control commands broadcast from a first network in a first format and re-broadcast to a set of consumer-electronic devices the remote control commands in a second network in a second format.

With portable devices, such as smartphones and laptop computers, in wide use, there is a desire by consumers of these portable devices to have the remote control functions of universal remote controls available on these portable devices for controlling consumer-electronic devices. The consumer-electronic devices may include set-top boxes, televisions, DVD players, satellite control boxes, stereo components, and the like. To satisfy the desire of consumers to have their portable devices provide remote control functions, developers have created remote control applications, which are operable on portable devices, for controlling consumer-electronic devices. The remote control applications often include computer code executable by a processor of a portable device where the processor controls the portable device's infrared (IR) transmitter to transmit IR device codes directly to a consumer-electronic device. The foregoing solution for operating a portable device for controlling a set of consumer-electronic devices generally requires that the portable device be in line-of-sight of the set of consumer-electronic devices to control the set of consumer-electronic devices.

While portable devices are currently configurable to execute remote control applications for controlling consumer-electronic devices, there is a desire by users to further use their portable devices for controlling the users' consumer-electronic devices while not within line-of-sight of a consumer-electronic device. There is also a desire by users to further use their remote control devices for controlling the users' consumer-electronic devices while not within line-of-sight of a consumer-electronic device. Therefore, there is an impetus for manufacturers to provide new remote control systems, which include portable devices and remote control configurable to operate as universal remote controls, but without the need to be in line-of-sight of a consumer-electronic device.

### BRIEF SUMMARY OF THE INVENTION

The present invention relates to a remote control system for controlling a set of consumer-electronic devices. More specifically, specific embodiment of the present invention relate to a remote-control system configured to receive remote control commands broadcast from a first network in a first format and re-broadcast to a set of consumer-electronic devices the remote control commands in a second network in a second format.

A remote control system in accordance with one embodiment of the present invention is configured for controlling a set of consumer-electronic devices and includes a first network configured for communication via a first format. The first network includes a router configured to receive packetized remote control codes transmitted to the router in the first format. The remote control system further includes a second network configured for communication via a set of second formats. The second network includes a translator communicatively coupled to the router via a network link (wired or wireless). The translator is configured to receive the packetized remote control codes from the router in the first format and translate the remote control codes from the first format to a set of second formats. The second network further includes a blaster communicatively coupled to the translator. The blaster is configured to received the packetized remote control codes in the set of second formats and transmit the packetized remote control codes in the set of second formats to a set of consumer-electronic devices to control the set of consumer-electronic devices.

According to a specific embodiment, the remote control system further includes a portable device configured to operate a remote control application for accepting a user selection for a set of actions for the set of consumer-electronic devices to execute and configured to transmit the packetized remote control codes to the router in the first format. The remote control codes are configured to control the set of consumer-electronic devices to execute the set of actions. The portable device may be a smartphone, a laptop computer, or a netbook computer. According to another specific embodiment, the portable device is configured to wirelessly transmit the packetized remote control codes in the first format to the router.

According to another specific embodiment, the first format is a network format and the set of second formats includes an IR format, a radio frequency (RF) format, and a high definition format. The network format may be a WiFi format. According to another specific embodiment, the first format may be a cellular phone network wherein the smartphone and the router are both configured for cellular telephone communication. The router is configured to receive a cellular telephone communication from the smartphone and the cellular telephone communication includes packetized remote control codes therein, and the router is configured to communicate the packetized remote control codes with the translator via WiFi, Ethernet or the like.

According to another specific embodiment, the remote control system further includes a third network, which includes a set of portable devices, wherein the third network is configured for communication via a third format. Each portable device in the third network is configure to wirelessly communicate in the third format with the translator to transmit packetized remote control commands to the translator in the third format. The translator is configured to receive the packetized remote control codes in the third format from the set of portable devices and translate the packetized remote control codes from the third format to the set of second formats. The third format may be a proprietary RF format. According to another specific embodiment, the third format may be a cellular phone network wherein the smartphone and the translator are both configured for cellular telephone communication. The translator is configured to receive a cellular telephone communication from the smartphone and the cellular telephone communication includes packetized remote control codes therein, and the translator is configured to communicate the packetized remote control codes with the blaster.

According to another specific embodiment, the translator and the blaster are integrated into a single device. According to another specific embodiment, the router and the translator are integrated into a single device. According to another specific embodiment, the router, the translator, and the blaster are integrated into a single device. The single device may be a computer system.

According to another specific embodiment, the remote control system further includes a computer system, which includes the translator, wherein the blaster is communicatively connected to the computer system via a bus. The computer system is configured to be communicatively connected to a select one of the consumer-electronic devices for streaming media to the select consumer-electronic device. The bus may be a Universal Serial Bus (USB).

According to one embodiment of the present invention, a remote control system configured for controlling a set of consumer-electronic devices includes a router configured to receive packetized remote control codes transmitted to the router in a first format. The remote control system further includes a translator communicatively connected to the router via a network connection. The translator is configured to receive the packetized remote control codes from the router in the first format and transmit the packetized remote control codes in a radio frequency (RF) broadcast in a second format. The remote control system further includes a blaster configured to received the packetized remote control codes in the RF broadcast, extract the remote control codes from the packetized remote control codes, and transmit the remote control codes in IR to a set of consumer-electronic devices to control the set of consumer-electronic devices.

According to a specific embodiment, the remote control system further includes a portable device configured to operate a remote control application for accepting a user selection for a set of actions for the set of consumer-electronic devices to execute. The portable device is configured to transmit the packetized remote control codes to the router, and the remote control codes are configured to control the set of consumer-electronic devices to execute the set of actions. The portable device may be a smartphone, a laptop computer, or a netbook computer. The portable device may be configured to wirelessly transmit the packetized remote control codes to the router.

According to another specific embodiment, the translator is configured to translate the packetized remote control codes from the first format to the second format. The first format is a network format and the second format is a radio frequency (RF) format. The first format may be a TCP/IP format. The router is configured to receive the packetized remote control codes transmitted wirelessly to the router.

According to one embodiment of the present invention, a combined translator-blaster device configured to control a set of consumer electronic devices includes a network interface controller configured to receive packetized remote control codes from a router on a first network via a network link, wherein the packetize remote control codes are in a first format, and includes a non volatile memory. The combined translator-blaster further includes a control signal transmitter configured to transmit the packetized remote control codes in the set of second formats to the set of consumer-electronic devices. The combined translator-blaster further includes a microprocessor connected to the network interface controller to receive information from the first network and transmit information to the first network, the microprocessor also being connected to the non volatile memory, the microprocessor also being connected to the control signal transmitter to transmit the packetized remote control codes to the set of consumer-electronic devices and the microprocessor being responsive to information received from the first network to cause the control signal transmitter to transmit the packetized remote control codes to the set of consumer-electronic devices to alter the state of the set of consumer-electronic devices.

According to a specific embodiment of the combined translator-blaster device, the non volatile memory is configured to store a representation of the state of the device in the non volatile memory, and wherein the microprocessor is further configured to update the stored representation of the state of the set of consumer-electronic devices to correspond with the altered state of the device.

According to another specific embodiment of the combined translator-blaster device, the combined translator-blaster device further includes a control signal receiver operable to receive control signals transmitted to alter the state of the set of consumer electronic devices. The microprocessor is responsive to the control signals for the set of consumer electronic devices received by the control signal receiver to alter the stored representation of the state of the set of consumer-electronic devices to correspond to the altered state of the device. The microprocessor is further configured to provide discovery and description functions and information to the network as a proxy for the set of consumer-electronic devices. The microprocessor is further configured to reply to requests from the first network for information relating to the state of the set of consumer-electronic devices with the corresponding information in the stored representation of the state of the consumer-electronic devices. The combined translator-blaster device may further include at least one sensor configured to obtain data relevant to the operation of the set of consumer-electronic devices, wherein the microprocessor is further configured to provide the obtained data to the first network.

According to one embodiment of the present invention, a remote control system configured for controlling a set of consumer-electronic devices includes: i) a first network, which includes a router configured to receive a first set of packetized remote control codes transmitted to the router in a first format from a first set of portable devices, wherein the first network is configured for communication via the first format; ii) a second network, which includes a second set of portable devices, wherein the second network is configured for communication via a second format, wherein each portable device in the second set of portable devices is configured to wirelessly communicate in the second format; and iii) a third network, which includes a combined translator-blaster device communicatively linked to the router via a network link and communicatively linked with the second set of portable devices. The third network is configured for communication via a set of third formats. The combined translator-blaster device is configured to receive the first set of packetized remote control codes from the router in the first format and translate the first set of remote control codes from the first format to a set of third formats, and transmit the first set of packetized remote control codes in the set of third formats to a set of consumer-electronic devices to control the set of consumer-electronic devices. The combined translator-blaster device is configured to receive a second set of packetized remote control codes from the second set of portable devices in the second format, translate the remote control codes from the second format to the set of third formats, and transmit the second set of packetized remote control codes in the set of second formats to the set of consumer-electronic devices to control the set of consumer-electronic devices.

According to a specific embodiment of the present invention, the first format is a WiFi format, the second format is a proprietary format, and the set of third formats includes IR, USB, HDMI-CEC, and/or RF4CE.

According to a specific embodiment of the present invention, each portable device in the first set of portable devices is configured to operate a remote control application for accepting a user selection for a set of actions for the set of consumer-electronic devices to execute and configured to transmit the first set of packetized remote control codes to the router in the first format, wherein the remote control codes are configured to control the set of consumer-electronic devices to execute the set of actions. The first set of portable devices may include a smartphone, a laptop computer, and a netbook computer. The combined translator-blaster device is a computer system. Each portable device in the second set of portable devices is configured to operate a remote control application for accepting a user selection for a set of actions for the set of consumer-electronic devices to execute and configured to transmit the second set of packetized remote control codes to the combined transceiver-blaster device in the second format, wherein the second set of packetized remote control codes are configured to control the set of consumer-electronic devices to execute the set of actions. The second set of portable devices may include a keyboard, a remote control, and a computer system.

These and other embodiments of the present invention are described in more detail in conjunction with the text below and the attached figures.

### BRIEF DESCRIPTION OF THE DRAWINGS

FIG. 1 is a simplified schematic of a remote control system according to one embodiment of the present invention;

FIG. 2 is a simplified schematic of the translator according to one embodiment of the present invention;

FIG. 3 is a simplified schematic of one of the blasters;

FIG. 4 is a further detailed schematic view of the remote control system shown in FIG. 1;

FIG. 5 is a simplified schematic of a remote control system according to another embodiment of the present invention;

FIG. 6 is a simplified schematic of a remote control system according to another embodiment of the present invention; and

FIG. 7 is a simplified schematic of a remote control system according to another embodiment of the present invention.

FIG. 8 is a schematic representation of an interface device in accordance with the present invention;

FIG. 9 is a schematic representation of another embodiment of the interface device of FIG. 8;

FIG. 10 is a schematic representation of another embodiment of the interface device of FIG. 8;

FIG. 11 is a schematic representation of another embodiment of the interface device of FIG. 8; and

FIG. 12 is a schematic representation of another embodiment of the interface device of FIG. 8.

### DETAILED DESCRIPTION OF SELECT EMBODIMENTS OF THE INVENTION

The present invention provides a remote control system for controlling a set of consumer-electronic devices. More specifically, specific embodiments of the present invention provide a remote-control system configured to receive remote control commands broadcast from a first network in a first format and re-broadcast to a set of consumer-electronic devices the remote control commands in a second network in a second format.

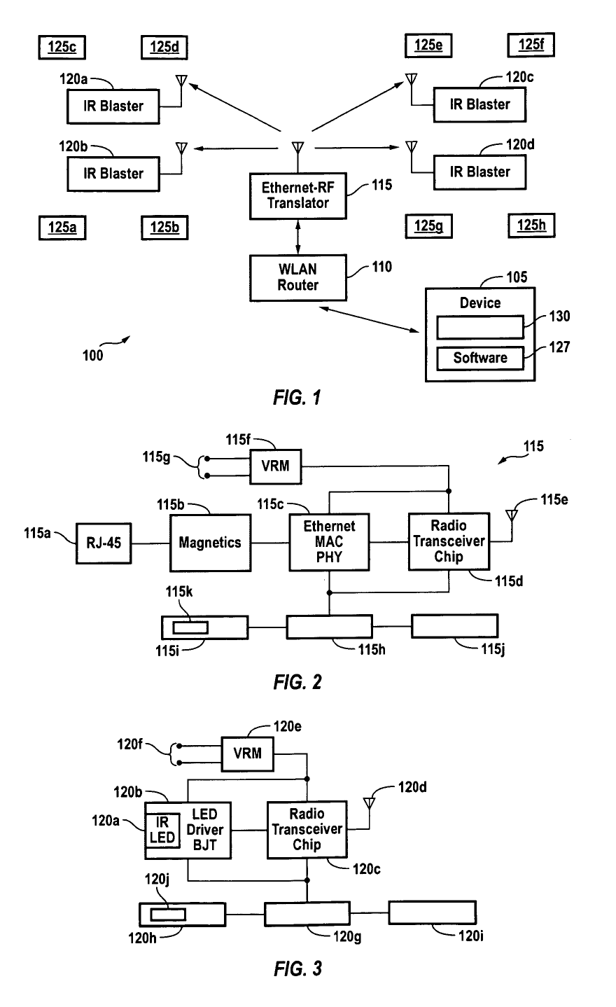

FIG. 1 is a simplified schematic of a remote control system 900 according to one embodiment of the present invention. Remote control system 900 includes a portable device 105, a router 110, a translator 115, and a set of blasters 120. Each blaster shown in FIG. 1 is labeled with the base reference number 120 and an alphabetic suffix. A set as referred to herein may include one or more elements. While router 110 and translator 115 are shown in FIG. 1 as two separate components, the router and translator may be included in a single combined device, where the combined device is configured to provide the functions of the both the router and the translator as described below. In one embodiment, the single combined device, which includes both the router and the translator, may be a computer. (e.g., a laptop computer). Also, while the translator and the set of blasters are shown in FIG. 1 as separate devices, the translator and one or more of the blasters may be included in a single combined device, where the combined device is configured to provide the functions of both the translator and the blaster. In one embodiment, the single combined device, which includes both the translator and the one or more of the blasters, may be a computer. (e.g., a laptop computer).

Remote control system 900 may be configured to control a set of consumer-electronic devices 125. Each consumer-electronic device shown in FIG. 1 is labeled with the base reference number 125 and an alphabetic suffix. The set of consumer-electronic devices includes, for example, a set-top box, a television, a satellite receiver, a DVD player, stereo equipment, lighting systems, kitchen appliances (stove, oven, microwave, refrigerator), window coverings, heating systems (e.g., a furnace), a surround sound system, etc. While the foregoing list includes one element of each type that may be included in the set of consumer-electronic devices, the set of consumer electronic devices may include more that one element of each type. For example, the set of consumer-electronic devices may include two or more set-top boxes, two or more televisions, etc. Furthermore, the preceding list is by no means exhaustive, and types of consumer-electronic devices not mentioned therein may also be controlled by a remote control system 900 in accordance with embodiments of the present invention. Remote control system 900 may be configured to turn on, turn off, change channels, change inputs (e.g., cable, satellite, auxiliary, etc.), etc. of the set of consumer-electronic devices. For example, the remote control system 900 may be configured to turn on a set-top box and a television. Remote control system 900 may be configured to set the input for the television to the set-top box and may be configured to change the channel of the set-top box to affect a channel change of the television. Remote-control system 900 may also be configured to dim room lighting while the television is turned on, turn on a surround sound system, etc. The foregoing list of uses of the remote control system controlling the set of consumer-electronic devices is exemplary. Those of skill in the art will know of other ways in which the remote control system will be able to control the set of consumer-electronic devices. Further specific details of how the remote control system controls the set of consumer-electronic devices are described in detail below.

According to one embodiment, router 110 may be a wireless router operating as a WLAN (wireless local area network) router. Router 110 may be configured to communicate via a network protocol (such as TCP/IP) with the portable device over a wireless link (e.g., WiFi link specified by the IEEE 802.11x standard). Router 110 may be located in a building, such as a house, and may be configured to communicate wirelessly with portable device 105, which may be located in the building or relatively near by the building.

Translator 115 may be an Ethernet to RF, USB and/or HDMI translator, which is configured to communicate via an Ethernet link (e.g., wired or optical) with the router and via RF links (a broadcast), USB links, and/or HDMI links with the set of blasters. As is well known in the art, USB stands for Universal Serial Bus, and HDMI stands for High-Definition Multimedia Interface. In one embodiment, the translator 115 is configured to translate the

Ethernet packets (e.g., TCP/IP packets) received from the router to an RF format, a USB format, or and/or an HDMI format. The RF format may include, but is not limited to, ZWave, Wifi, RF4CE (Remote Control Standard for Consumer Electronics), and the like. Z-Wave, as is well known in the art, is a proprietary wireless communications protocol designed for home automation, specifically to remote control applications in residential and light commercial environments. Z-Wave technology uses a low-power RF radio embedded in home electronics devices and systems, such as lighting, home access control, remote controls, consumer-electronic devices, and the like.

The blasters in the set of blasters 120 may be located in various rooms of a building. Each room that includes a blaster may also include one or more of consumer-electronic devices 125. A blaster 120 in the same room with one or more consumer-electronic devices 125 may be configured to transmit IR device codes via IR, RF4CE, HDMI, or the like to the one or more consumer-electronic devices 125 in the room to control these one or more consumer-electronic devices. If the blaster is configured to transmit IR device codes in IR, the blaster is sometimes referred to as an IR blaster. It will be understood by those of skill in the art that while the term

“IR devices codes” includes the term “IR”, the term “IR” derives from historical communication of device codes in IR from a remote control to a consumer electronic device, such as a television. While the term “IR device codes” is used herein, it will be understood that IR device codes may be transmitted in IR, RF, optical wavelength (e.g., on fiber optics), or the like and in a variety of formats.

According to one embodiment, portable device 105 is configured to operate a remote control application 127 (e.g., a software application). Portable device 105 may include a display, a set of buttons (e.g., soft buttons on the display), a processor, memory, control logic circuits, an RF transceiver, and the like for operating the remote control application. The remote control application operating on portable device 105 may be configured to control the set of consumer-electronic devices via the router 110, the translator 115, and one or more of the blasters 120. The display may be configured to display a user interface for the remote control application where user selectable options are displayed for controlling the consumer-electronic devices 105. For example, the user interface may provide user selectable options for turning on a television, a set-top box, a DVD player or the like, selecting an input for the television (e.g., the set-top box), and selecting a television channel for the set-top box to pass through to the television for presenting the television channel on the television. The user interface may also display user selectable options for turning on a surround sound system for the television or a stereo system. The user interface may also display user selectable options for dimming light or closing curtains. The user interface may also display user selectable options for turning on a video surveillance system (e.g., a web cam and computer) and/or an audio surveillance system (e.g., a microphone on the web cam or the computer) for transmission of video and or audio to the portable device via the Internet or the like. The foregoing is a limited number of examples of control functions that the portable device may provide via operation of the remote control appliance. Those of skill in the art will know of other remote control function that the remote control appliance may be configured to perform while executed on the portable device.

According to one embodiment, the memory of portable device 105 is configured to store an IR device codeset database 130, which includes an IR device codeset. The IR device codeset includes information for a set of IR device codes for controlling the set of consumer-electronic devices. The information for the IR device codes may be hexadecimal codes, where each unique hexadecimal code represents one of the IR device codes (e.g., turn on the TV, turn off the TV, change the channel on the set-top box, turn up the volume on the TV, turn down the volume on the TV, etc.). According to one embodiment, the processor of portable device 105 executing the computer code for the remote control application is configured to receive a set of user selections via the set of buttons for the user selectable option. The processor is configured to retrieve from the IR device codeset database one or more IR device codes (e.g., one or more of the hexadecimal codes), which correspond to the functions for the set of user selections. The processor is configured to packetize the one or more IR device codes according to the network protocol (e.g., TCP/IP) and control the transmitter of the portable device to transmit the one or more packetized IR device codes to the router. According to one embodiment, the portable device may include a LAN port through with the one or more packetized IR device codes are transmitted to router 110. According to various alternative embodiments, the translator may includes the IR device codeset database 130 or the blasters might includes the IR device codeset database 130. According to these latter alternatives, the portable device might transmit to the router a set of remote control codes, which identifies a function to be performed by one or more of the consumer electronic device, but where the actual IR device codes are retrieved at the translator or the blasters for transmission of the IR device codes to the consumer-electronic devices.

Portable device 105 may be one of a variety of portable devices, which is configurable for receiving, storing, and executing the remote control application. The portable device may be a personal digital assistant, a mobile phone, a smartphone (e.g., an iPhone™ of Apple Computer, Inc of Cupertino Calif., an HTC Eris Droid™ of HTC of Taiwan, etc.), a laptop computer, a netbook computer, or the like. The portable device may be configured to receive the remote control application from a number of sources such as a memory card, a disk, a network connection, or the like.

FIG. 2 is a simplified schematic of translator 115 according to one embodiment of the present invention. The translator may include a connector 115a, a set of magnetic devices 115b, an Ethernet MAC PHY chipset 115c operating as an Ethernet port, a radio transceiver chip 115d, an antenna 115e, a voltage regulator 115f, and a DC wall adapter 115g, which is configured to plug into a standard wall socket. Translator 115 may also include a processor 115h, a memory 115i, control logic 115j, and/or the like. The connector may be an RJ-45 connector, an 8P8C connector, or the like for connecting translator 115 to router 110. The set of magnetic devices may include an isolation transformer coupled between the translator's Ethernet port and the router. The Ethernet MAC PHY chipset may operate according to IEEE standard 802.3 standard MAC (media access controller) and PHY (physical interface transceiver). The DC wall adapter may be a simplified voltage doubler circuit (SVDC) wall adaptor. The voltage regulator may be configured to convert DC voltage (e.g., 5 volts) output from the DC wall adaptor to another useful voltage (e.g., 3.3 volts), which may be used to power the Ethernet MAC PHY chipset, the radio transceiver chip, the processor, the memory, the control logic, etc.

According to one embodiment, translator 115 is configured to receive the packetized IR device codes from router 110 via connector 115a and Ethernet MAC PHY chipset 115c. The radio transceiver chip in combination with the antenna is configured to transmit the packetized IR device codes in an RF format to one or more of the blasters 120. Translator 115 may include control software 115k, which is stored in the translator's memory and executed by the translator's processor to translate the packetized IR device codes from the network format (et TCP/IP) to the RF format codes. The processor executing control software 115k may also control the pass through of the packetized IR device codes from the connector and Ethernet MAC PHY chipset to the radio transceiver chip and the antenna.

FIG. 3 is a simplified schematic of one of the blasters 120 in the set of blasters 120 according to one embodiment of the present invention. Each of the blasters 120 in the set of blasters may be similarly configured to the blaster shown in FIG. 3 and described in further detail below. The blaster 120 includes an IR transmitter 120a, an LED-driver bipolar junction transistor (BJT) 120b, a radio transceiver chip 120c, an antenna 120d, a voltage regulator 120e, and a DC wall adapter 120f. The blaster 120 may also include a processor 120g, a memory 120h, control logic 120i, and/or the like.

Voltage regulator 120e is coupled to DC wall adapter 120f, and voltage regulator 120e and DC wall adapter 120f are configured to operate similarly to voltage regulator 115f and a DC wall adapter 115g as described above. According to one embodiment, voltage regulator 120e and DC wall adapter 120 are configured to power the LED-driver BJT, the IR transmitter via the LED-driver BJT, the radio transceiver chip, the processor, the memory, the control logic, etc. According to one embodiment, blaster 120 is configured to receive the packetized IR device codes from the translator and process the packetized IR device codes to transmit from the IR transmitter (e.g., an IR LED) the IR device codes in IR. The processing of the packetized IR device codes may be performed by processor 120g executing software 120j provided to processor 120g by the memory 120h. The IR device codes transmitted in IR may be received by one or more IR receivers on the consumer-electronic devices, which are in the same room as the blaster.

According to one embodiment, the blaster's processor is configured to control the LED-driver BJT to generate relatively high current pulses in a temporal pattern to change the IR transmission intensity (e.g., from on to off, off to one, from relatively low intensity to relatively high intensity, or from relatively high intensity to relatively low intensity) for transmitting the IR device codes to the consumer-electronic devices.

In one embodiment, with translator 115 attached to the access point (Ethernet) and the blasters 120 in cabinets, the RF links between translator 115 and blasters 120 may be relatively long range. In one embodiment, these long range links require high power, and thus requires blasters 120 to be powered.

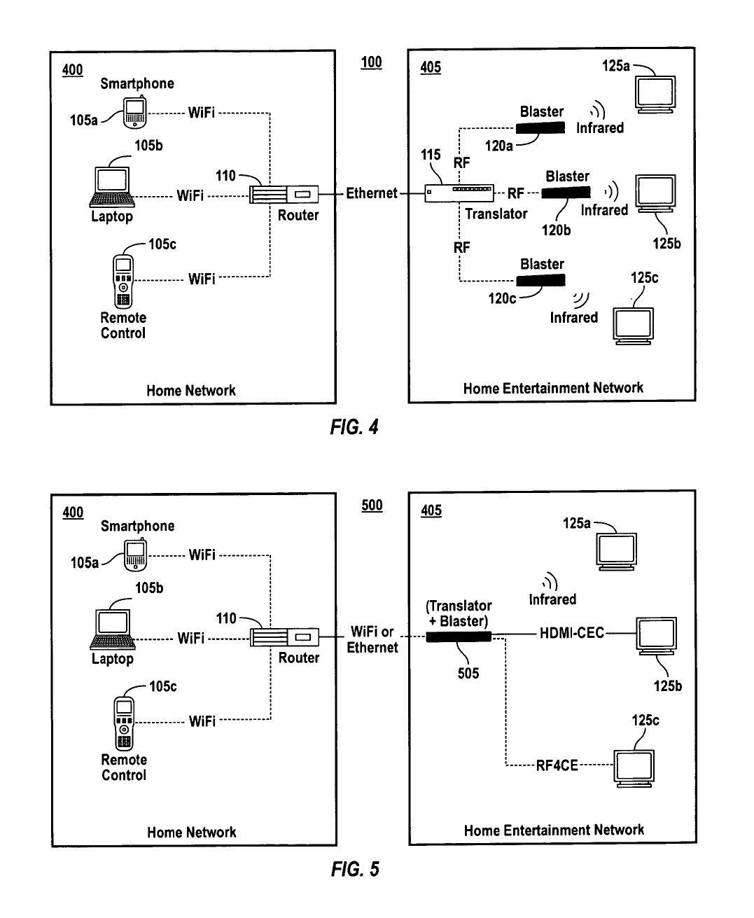

FIG. 4 is a schematic of remote control system 100 shown in further detail. Portable device 105a (a smartphone), portable device 105b (a computer system (e.g., a laptop computer)), portable device 150c (a remote control), and router 110 are shown as part of a first network 400, which is labeled the home network. The first network may be a TCP/IP based network. While the embodiment of remote control system 100 shown in FIG. 4 includes three portable devices, the remote control system may include more or fewer portable devices. For example, a family might own a number of smartphones and a number of laptop computers, which are configured as portable devices as described herein to control the set of consumer-electronic devices 125. As described above, the portable devices are configured to communicate via a first communication protocol with router 110. The communication protocol may be a WiFi protocol (IEEE 801.11x).

As further shown in FIG. 4, translator 115 is coupled to router 110 via an Ethernet connection. Router 115 and the set of blasters 120 are part of second network 405, which is labeled the home entertainment network. First network 400 uses a first set of communication protocols and second network 405 uses a second set of communication protocol (IR, HDMI-CEC, RF4ce, etc). Translator 115 provides for the conversion of communication formats and protocols between the first network 400 and the second network 405. While FIG. 4 shows the router and the translator as discrete devices, the router and translator may be combined into a combined router-translator device, which may be a computer system.

According to another embodiment, the smartphone and the router are both configured for cellular telephone communication. The router may configured to receive a cellular telephone communication from the smartphone and the cellular telephone communication includes packetized remote control codes therein, and the router is configured to communicate the packetized remote control codes to the translator via WiFi, Ethernet, or the like as described above.

FIG. 5 is a simplified schematic of a remote control system 500 according to another embodiment of the present invention. Remote control system 500 provides similar remote control functions compared to remote control system 100, but differs from remote control system 100 in that translator 115 is combined with one of the blasters 120 into a single combined translator-blaster device 505. Translator-blaster device 505 may be a computer system, such as a laptop computer. Remote control system 500 further differs from remote control network 100 described above in that the communication link between the router 110 and translator 115 may be an Ethernet connection or a WiFi link. FIG. 5 further shows that the communication links between combined translator-blaster device 505 and the set of consumer-electronic devices 125 may take a variety of formats such as IR, HDMI-CEC (HDMI Consumer Electronics Control), RF4CE, etc. That is, the IR command codes (codes that were originally configured for IR communication between a remote control and a consumer-electronic device) may be delivered to the consumer-electronic devices in a variety formats and a variety of wavelengths other than IR.

While FIG. 5 shows that the translator and the blaster are combined into the combined translator-blaster device 505, according to one embodiment, the router is included in the combined translator-blaster device, which may be a computer system.

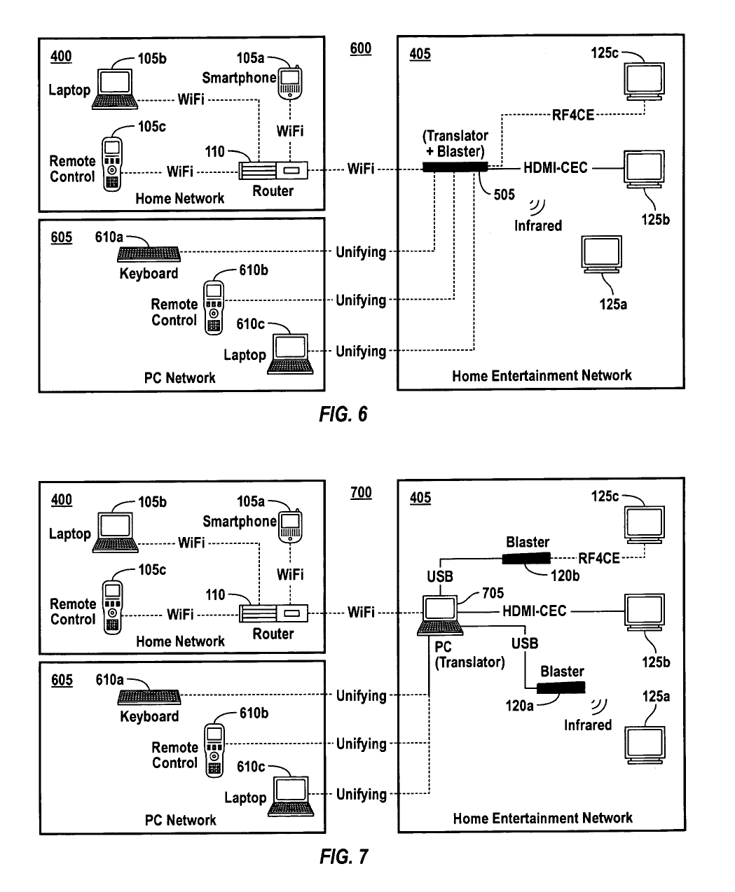

FIG. 6 is a simplified schematic of a remote control system 600 according to another embodiment of the present invention. Remote control system 600 provides similar remote control functions compared to remote control systems 100 and 500, but differs from remote control systems 100 and 500 in that combined translator-blaster device 505 is configured to communicate not only with the router in the first network 400, but is also configured to communicate with a third network 605, which is labeled the PC network. Third network 605 includes a set of portable devices 610, which are configured to communicate with combined translator-blaster device 505 via a propriety communication protocol (e.g., a proprietary RF communication protocol), a proprietary communication format (e.g., packet format), and a proprietary control system (e.g., a proprietary RF control system). According to one embodiment, the proprietary communication RF protocol and the proprietary RF control system are, respectively, Logitech's Unifying™ RF protocol and Logitech's Unifying™ proprietary RF control system described in U.S. Provisional Patent Application No. 61/230,665, filed Jul. 31, 2009, titled “Receiver Configured to Pair to Multiple Wireless Devices”, of Jacques Chassot et al., and which is incorporated by reference herein in its entirety for all purposes. According to one embodiment, the set of portable devices 610 may include a computer keyboard 610a, a remote control 610b, a computer system 610c (e.g., a laptop computer), etc. The set of portable devices are configured to transmit remote control commands in the proprietary communication protocol and the combined translator-blaster device is configured to translate the remote control commands in the proprietary communication protocol to IR, HDMI-CEC, RF4CE, etc.

According to another embodiment, smartphone 610b and combined translator-blaster device 505 (or a stand along translator, such as translator 115) are both be configure for cellular telephone communication. Combined translator-blaster device 505 (or translator 115) may configured to receive a cellular telephone communication from the smartphone and the cellular telephone communication includes packetized remote control codes therein, and combined translator-blaster device 505 (or translator 115) is configured to communicate the packetized remote control codes in a translated format with the consumer-electronic devices as described above. In the embodiment where the smartphone is configured to send a cellular telephone communication to translator 115, the translator may communicate with the set of blasters 120 as described above.

FIG. 7 is a simplified schematic of a remote control system 700 according to another embodiment of the present invention. Remote control system 700 provides similar remote control functions compared to remote control systems 100, 500, and 600, but differs from remote control systems 100 and 500 in that translator 115 is embodied in a computer system 705 (such as a laptop computer, a netbook computer, etc.). Computer system 705 may be connected to a television 710 via a HDMI-CEC connection to the like to stream media (e.g., video, audio, and/or multimedia (e.g., video and audio)) to the television. The computer system 705 may be connected to the set of blasters via a set of USB connections, for example. The computer system may be configured to stream media, which is locally stored on the computer system or is received from a network (e.g., the Internet, an intranet, etc.).

As used herein below, the term “legacy device” (e.g., consumer-electronic device) is intended to comprise any device which is not inherently compliant with the network to which it is desired to connect the device. In many cases, such legacy devices are only able to receive control signals from a controller, such as an infrared remote control, and cannot communicate back to the controller. Consumer electronics networks, such as UPnP or HAVi, require a bi-directional communications link to the devices to be controlled and, accordingly, it is not presently possible to use such consumer electronics networks to directly control many legacy devices. In other cases, the legacy device may have been manufactured for use with a network of a type other than the type of the network to which it is desired to connect the device, or the legacy device may implement an earlier (not backward compatible) version of the network standard, etc. In such cases it is also not possible to use such consumer electronics networks to directly control such legacy devices.

Examples of legacy devices can include, without limitation, television sets equipped with infrared remote controls, stereo systems equipped with infrared remote controls, air conditioner units equipped with infrared or ultrasonic remotes, etc.

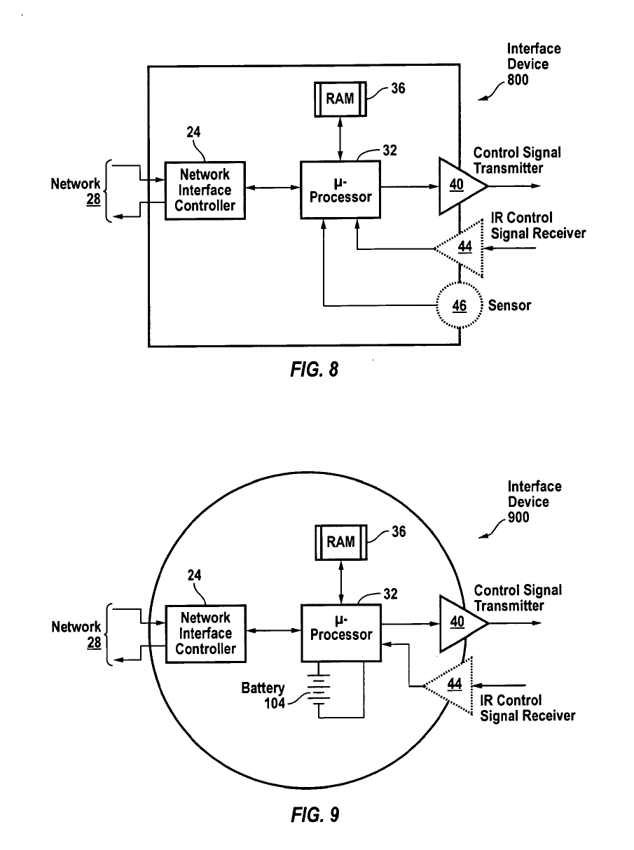

An interface device for connecting legacy devices to consumer electronics networks, in accordance with the present invention, is indicated generally at 20 in FIG. 8. Interface device 20 includes a network interface controller 24 which is operable to interface electrically and logically with a network 28, which preferably is a consumer electronics network, such as UPnP or HAVi or the like. Interface device 20 may be translator 115 or may be combined translator-blaster device 505.

If network 28 is a proprietary network, or otherwise employs non-standard physical or transport protocols, network interface controller (NIC) 24 can comprise purpose built electronic interface circuitry and/or a microprocessor executing a firmware program to provide the necessary functionality for network 28. However, to date consumer electronics devices are typically connected to networks such as UPnP and HAVi which are implemented over standard physical network layers, such as Firewire (IEEE 1394), WiFi (IEEE 802.11x) or wired Ethernet and employ standard transport protocols such as UDP/IP or TCP/IP. Accordingly, for cost and/or convenience, it is preferred that network 28 be implemented with such standards so that network interface controller 24 can be a standard “off the shelf” NIC for such standard networks.

Interface device 20 further includes a microprocessor 32 which is connected to network interface controller 24 and which is operable to receive, process and reply to command or other messages over network 28 via network interface controller 24. Microprocessor 24 can be any suitable microprocessor or microcontroller, as will occur to those of skill in the art. If device 20 is to be powered by battery, as discussed below, it is preferred that microprocessor 24 be of a low power consumption design.

Microprocessor 32 is connected to a non volatile RAM 36 to store configuration data and/or state data from the consumer electronic device being controlled by interface device 20, as described below in more detail. RAM 36 can be an integral part of microprocessor 32, or can be a separate device connected to processor 32 via an appropriate bus and RAM 36 can be any form of non-volatile RAM including battery backed-up static RAM, Flash ROM, etc.

Microprocessor 32 is further connected to a control signal transmitter 40 which is operable to transmit control signals to consumer electronics devices to be controlled via network 28. It is contemplated that control signal transmitter 40 will most commonly be an infrared (“IR”) transmitter which is operable to transmit appropriate control signals, via infrared, to legacy consumer electronic devices. However, the present invention is not limited to the transmission of infrared control signals to the devices to be controlled and other transmission modalities, such as radio (RF) or acoustic (ultrasonic), can be employed instead of infrared signals. It is also contemplated that interface device 20 can include more than one control transmitter 40, each of which can employ a different transmission modality.

Interface device 20 can also optionally include one or more control signal receivers 44, each of which is operable to receive control signals transmitted to legacy devices from their associated remote controller units, as described in more detail below.

Interface device 20 can be powered via any appropriate means, as will occur to those of skill in the art. For example, if network 28 is a Firewire network, interface device 20 can be powered by the connection to network 28 as the Firewire standard permits such connections. Interface device 20 can also be powered by batteries (not shown), a combination of solar cell and batteries, AC mains supply or any other suitable power source, as will occur to those of skill in the art.

Interface device 20 can also include one or more other sensors 46, such as temperature or light level sensors to provide additional functionality. For example, if interface device 20 is used to connect a legacy air conditioning unit to network 28, then interface device 20 can include a temperature sensor which can provide network 28 with a measure of the temperature adjacent sensor 46, which is presumably located near the legacy air conditioning unit. Similarly, if interface device 20 is used to connect a legacy lighting control system to network 28, interface device 20 can include one or more light sensors which can provide network 28 with a measure of the light levels adjacent sensor 46.

It is contemplated that sensors 46 can be included in interface device 20 or, if desired, can be located some distance from interface device 20 and connected thereto by a wired or by a wireless connection. For example, sensor 46 can include an IR transmitter which transmits the sensed data to an IR control signal receiver 44 in interface device 20, or sensor 46 can include a radio transmitter, such as a Bluetooth transmitter, which transmits the sensed data to a Bluetooth control signal receiver 44 in interface device 20. As will be apparent, the above-mentioned temperature and light sensors are only examples of sensors 46 which can be employed with interface 20 and many other sensor types can be employed with interface device 20 as will occur to those of skill in the art. Similarly, the above-mentioned Bluetooth and IR links between sensors 46 and interface device 20 are only examples of possible connections to sensors 46 and many other connection types can be employed with interface device 20 such as wired USB connections, etc. as will occur to those of skill in the art.

Interface device 20 provides a method to connect legacy devices to consumer electronics networks. Interface device 20 maintains a representation of the state of the consumer electronics device being controlled via interface device 20. As used herein, the team “state” is intended to comprise an appropriate description of the operating configuration of the consumer electronics device. For example, the state of a television device can include the power status (On or Off) of the device, the channel the device is tuned to, the input it is using (DVD, Tuner, VCR), whether Picture in Picture has been activated, etc.

U.S. Pat. No. 6,784,805 to Harris et al., assigned to the assignee of the present invention, teaches a remote control for legacy devices which stores a representation of the state of the device(s) being controlled and the contents of this patent are incorporated herein by reference. In a manner similar to that taught in Harris, interface device 20, maintains a state representation for devices it is controlling. Specifically, a representation of the state of the legacy device is stored in RAM 36 and is formed by placing the consumer electronics device into a known state, such as powered off, and then updating the state representation stored in RAM 36 appropriately, as each command signal is transmitted from control transmitter 40 to the consumer electronics device.

Provided that the state of the consumer electronics device is only changed via control transmitter 40 of interface device 20, the state representation in RAM 36 will be an accurate representation of the state of the legacy device. If interface device 20 is optionally equipped with control signal receiver 44 which can receive control signals sent to the consumer electronics device from other controllers, such as a legacy IR remote control, then such a legacy IR remote control can also be employed to control the legacy device in a conventional manner, provided that control signal receiver 44 can also receive the signals transmitted from the conventional controller to the legacy device. In this case, interface device 20 will use the signals received from the legacy IR remote control to appropriately update its representation of the state of the legacy device.

For example, if a user employs the legacy IR remote control for a television set to change the channel of that set, control signal receiver 44 can also receive the IR command to change the channel and interface device 20 can then update the representation of the state of the television in RAM 36 to reflect the new channel the television is tuned to.

As will be apparent, it is possible that the state representation in RAM 36 can differ from the actual state of the legacy device and appropriate means can be employed to resynchronize the actual state of the legacy device and the representation of the state of the legacy device stored in RAM 36. For example, the user can place the legacy device into a predefined known state (such as set to channel two and powered off, etc.) and then reset interface device 20 by activating a reset switch (not shown) on interface device 20. When reset, interface device 20 can reconstruct an appropriate corresponding default representation of the state of the legacy device to resynchronize with the actual state of the legacy device.

More preferably, an interactive device, such as a personal computer also attached to network 28, can display interactive prompts, created by microprocessor 32 and forwarded to the interactive device over network 28, and the user can provide input through the interactive device to be forwarded back to microprocessor 32 in interface device 20. For example, a prompt such as “is the television set on? (Y/N)” can be shown to the user and the user can use the interactive device to reply “Y” or “N” as appropriate, to resynchronize the stored representation of the state of the legacy device with the actual state of the legacy device.

As will be apparent, to control and to construct and maintain a representation of the state of a legacy device, interface device 20 must know the signals of the command set, for transmission by control signal transmitter 40, which the legacy device can understand and the capabilities and features of the legacy device. Preferably, interface device 20 can be provided with such information via network 28 which, in turn, obtains such information from a previously established database. Such a database can be available to interface device 20 via a connection to the internet, in which case interface device 20 must be able to connect to the internet via an appropriate network connection, such as a direction connection or a connection through another device on network 28, or from a CD ROM or other mass storage device which is connected to network 28, or via any other suitable means, as will occur to those of skill in the art. Alternatively, provided that interface device 20 is equipped with optional control signal receiver 44, interface device 20 can “learn” the characteristics of a legacy device in manner similar to that described in the above-mentioned Harris et al. patent and/or the method employed with conventional trainable remotes. In such a case, the learning process can be simplified if an interactive device, such as a personal computer, which is connected to network 20, is used to prompt the user and receive the user's responses as to the type of legacy device (i.e., television, surround sound system, CD player, DVD player, Air Conditioner, etc.), the capabilities of the device (i.e., multi-disc player, Television with Picture in Picture, etc.) and to prompt the user to active the appropriate commands of the legacy remote for capture by control signal receiver 44.

It is also contemplated that, if interface device 20 does not have optional control signal receiver 44, legacy devices can still be learned, provided that another device connected to network 28 does have such a receiver and can be used to capture the legacy commands from the legacy controller. In particular, it is contemplated that if one interface device 20 on a network 28 has optional control signal receiver 44, it can be used to capture legacy commands and forward them to another interface device 20 on network 28 which will control the legacy device being learned.

Thus, as part of the set up and configuration of an interface device 20, microprocessor 32 is provided with the necessary information such that it can construct and maintain a representation of the state of the legacy device and such that it can transmit valid commands, via control signal transmitter 40, to the legacy device.

Once interface device 20 has been set up such that it knows the legacy device it is controlling, interface device 20 can perform the “discovery” and “description” functions, or their equivalents, required by the consumer electronics network 28 for devices connected thereto and can respond appropriately to commands from network 28 . Effectively, interface device 20 acts as a bi-directional communication proxy for the legacy device, even if the legacy device in fact only features a uni-directional command system (e.g., an IR receiver).

Commands sent via network 28 to the legacy device are interpreted by interface device 20. If the received commands require a response, interface device 20 can respond on network 28 appropriately, referring if necessary to the representation of the state of the legacy device stored in RAM 36. For example, network 28 may query whether the legacy device is presently turned on and interface device 20 will check the representation of state stored in RAM 36 and will formulate and transmit an appropriate reply on network 28.

If network 28 sends a command to change the state of the legacy device, for example to turn the television on and change it to a particular channel, interface device 20 will determine which commands need to be transmitted from control signal transmitter 40 to effect the necessary state change (referring if necessary to the representation of the state of the legacy device in RAM 36) and will transmit those necessary commands to the legacy device from control signal transmitter 40, will update the stored representation of the state of the legacy device in RAM 36 and will transmit any required confirmation or acknowledgement signal back to network 28.

Interface device 20 can further enhance the operation of a legacy device by providing emulation for commands which are not natively available to the legacy device. For example, a legacy television may not have a native command allowing a channel to be directly tuned (i.e., jump to channel twenty seven) and may instead only provide “channel up” and “channel down” commands. Interface device 20 can include in the stored representation of state in RAM 36 the channel the television is presently tuned to. If network 28 sends a command to interface device 20 to change the selected channel from twenty two to twenty seven, for example, interface device 20 can determine a strategy to tune in the selected channel, by transmitting the appropriate number of either channel up or channel down commands to change the presently selected channel on the television to the requested channel. In this particular example, interface device could send five “up channel” commands with any necessary delays between the transmission of each command.

Preferably, when interface device 20 is first connected to network 20 it performs native discovery and description functions, or their equivalent, to announce its native presence to devices on network 28. These native functions establish the necessary parameters for interface device 20 to be configured to learn the legacy device it is to control, with the assistance of another interactive device connected to network 28 and/or with access to a database of legacy device configurations via a mass storage device connected to network 28, or via a connection to a remote database via the Internet or the like. Once interface device 20 has been configured with the characteristics of the legacy device and its representation of the state of the controlled legacy device has been established, interface device 20 can re-perform the discovery and description functions for network 28 to identify itself as a compliant version of the legacy device. It is contemplated that this identification as a compliant version of the legacy device will be in addition to its identification as its native self so that a network 28 can directly access interface device 20 to reset it, or to otherwise send it commands which interface device 20 can natively process.

While in the discussion above interface device 20 has only controlled a single legacy device, it will be appreciated that the present invention is not so limited and interface device 20 can in fact control two or more legacy devices. In such a case, RAM 36 need have sufficient capacity to store a representation of the state of each legacy device to be controlled. Also either control signal transmitter 40 must be able to generate control signals appropriate for each legacy device to be controlled, or additional control signal transmitters 40 must be provided, each being capable of transmitting appropriate control signals to at least one of the legacy devices to be controlled.

In such an embodiment, wherein interface device 20 is used to control two or more legacy devices, interface device 20 will provide discovery and description functions to network 28 for each legacy device to be controlled.

In FIGS. 2 through 5, discussed below, elements which are substantially the same in operation and/or function as elements in FIG. 8 are identified with the same reference numbers as those used in FIG. 8.

In a presently preferred embodiment, shown in FIG. 9, interface device 20 is implemented as a small device 900, which can be mounted on or near a legacy device to be controlled, such that signals from control signal transmitter 40 can be received by the legacy device. In the illustrated configuration, interface device 20 is powered by battery 104 and is preferably designed and constructed to provide a reasonable battery life and the connection of interface device 20 to network 28 is preferably achieved by a wired connection. It is contemplated that interface device 900 can be in the form of a disc, or the like, and can have control signal transmitter 40 on one side of the disc and control signal receiver 44 on the opposite side. Device 900 can be attached, adhesively or otherwise, to the IR receiver window of the legacy device to be controlled with control signal transmitter 40 facing the IR receiver window and control signal receiver 44 facing the opposite direction. In such a configuration, interface device 900 will function as described above and will also be operative to “pass through” control signals received from a legacy control device such as an IR remote control by receiving, via control signal receiver 44, and repeating, via control signal transmitter 40, those control signals. As will be apparent, as device “passes through” control signals from a legacy controller, the representation of the state of the legacy device stored in RAM 36 is appropriately updated.

Device 900 is believed to be particularly advantageous, in terms of function and cost, for use with legacy IR-based devices such as television sets or the like as it allows for the television to be a compliant component on network 28 while also allowing a user to control the legacy device in a conventional manner.

If the particular implementation of network 28 provides for attached devices to be powered by the network, such as with a Firewire network, battery 104 can be omitted from device 900 which can be powered by network 28.

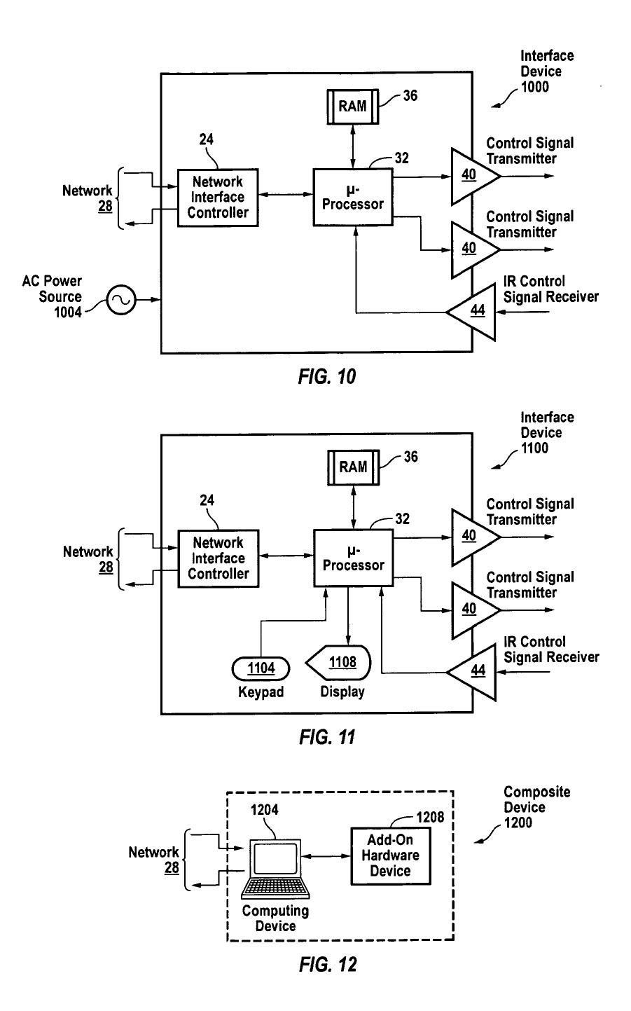

In another presently preferred embodiment shown in FIG. 10, interface device 20 is implemented as an AC powered device 1000 connected to an AC supply 204. Device 1000 is preferably positioned such that signals from the one of the at least one control signal transmitters 40 can be received by the legacy device, or devices, to be controlled. As power conservation is not an issue for device 204, connection of device 1000 to network 28 can be achieved in a wide variety of manners, including wireless connections (such as WiFi), AC power data connections, etc. It is contemplated that, for example, this embodiment of interface device 20 can be placed on an end table or coffee table adjacent a home theatre system and can be used to control all of the legacy devices in the home theatre system.

In yet another embodiment of the present invention illustrated in FIG. 11, interface device is implemented as an interactive device 1100 on network 28. As shown, in addition to the components discussed above, device 1100 includes a keypad 1104 and a display 1108, such as an LCD panel. Keypad 1104 and display 1108 allow a user to configure and/or interact with device 1100 to, for example, configure device 1100 for the legacy devices it is to interface. Further, keypad 1104 and display 1108 can allow a user to interact with other devices connected to network 28 and can provide desired information, such as television listings, room temperature, etc. to a user.

While the embodiments described above have illustrated interface device 20 as a unitary device, it is also contemplated by the present inventors that interface device 20 can be obtained as a composite of an existing device on network 28 executing appropriate software and an add-on device to that existing device. In particular, FIG. 12 illustrates a composite device 1200 including a general purpose computing device 1204, such as a personal computer, which is a compliant device on network 28. An add-on hardware device 1208 is connected to computing device 1204 and includes at least one control signal transmitter 40 and, preferably, at least one control signal receiver 44. Computing device 1204 includes a microprocessor or the like which performs the functions of microprocessor 32 and includes RAM memory and non-volatile storage, such as a disc drive or Flash ROM, which can be used to store a representation of the state of each legacy device to be interfaced by device 1200. Add-on hardware device 1208 can be in suitable form, such as a USB “dongle” or the like.

If a computing device, such as general purpose computing device 1204 is present on network 28, composite device 1200 provides many advantages including a greatly reduced cost, as it is only necessary to provide appropriate software to general purpose computing device 1204 and add-on device 1208, which can be relatively inexpensive to manufacture due to its simplicity. In addition, the computing resources typically present in general purpose computing devices, such as personal computers, are typically much greater than those which could cost-effectively be provided in the other embodiments of device 20 described above, allowing for enhanced functionality to be provided by composite device 1200. Such enhanced functionality can include, without limitation: timed functions, i.e., sending desired control signals to legacy devices at pre-selected times o activating a legacy device for a selected duration of time, etc.; adaptive functions, i.e., activating a legacy air conditioner when a sensed temperature is exceeded, or turning on a room lighting system when a person enters a room, or turning on a legacy television set to a channel previously being watched by a user in another room when the user enters that room and turning off the legacy television in that other room which is no longer being watched; etc.

The present invention provides a novel device and method for connecting devices which are not inherently compliant with a network to such a network. In particular, the interface device creates and maintains a representation of the state of the device and uses this stored representation to provide information about the state of the device in response to requests for such information from the network. The device can provide enhanced commands which are not inherently supported by the device.

It is to be understood that the examples and embodiments described above are for illustrative purposes only and that various modifications or changes in light thereof will be suggested to persons skilled in the art, and are to be included within the spirit and purview of this application and scope of the appended claims. Therefore, the above description should not be understood as limiting the scope of the invention as defined by the claims.

What is claimed is:

1. A remote control system configured for controlling a set of consumer-electronic devices comprising:
a first network includes a router configured to receive packetized remote control codes transmitted to the router in a first format, wherein the first network is configured for communication via the first format; and
a second network includes:
a translator communicatively coupled to the router via a network link, wherein the translator is configured to receive the packetized remote control codes from the router in the first format and translate the remote control codes from the first format to a set of second formats, wherein the second network is configured for communication via the set of second formats; and
a blaster communicatively coupled to the translator and configured to received the packetized remote control codes in the set of second formats and transmit the packetized remote control codes in the set of second formats to a set of consumer-electronic devices to control the set of consumer-electronic devices.

2. The remote control system of claim 1, further comprising a portable device configured to operate a remote control application for accepting a user selection for a set of actions for the set of consumer-electronic devices to execute and configured to transmit the packetized remote control codes to the router in the first format, wherein the remote control codes are configured to control the set of consumer-electronic devices to execute the set of actions.

3. The remote control system of claim 2, wherein the portable device is a smartphone, a laptop computer, or a netbook computer.

4. The remote control system of claim 2, wherein the portable device is configured to wirelessly transmit the packetized remote control codes in the first format to the router.

5. The remote control system of claim 1, wherein the first format is a network format and the set of second formats includes an IR format, a radio frequency (RF) format, and a high definition format.

6. The remote control system of claim 5, wherein the first format is a WiFi format.

7. The remote control system of claim 6, wherein the first format is a TCP/IP format.

8. The remote control system of claim 1, further comprising a third network, which includes a set of portable devices, wherein the third network is configured for communication via a third format, wherein:
each portable device is configure to wirelessly communicate in the third format with the translator to transmit packetized remote control commands to the translator in the third format, and
the translator is configured to receive the packetized remote control codes in the third format from the set of portable devices and translate the packetized remote control codes from the third format to the set of second formats.

9. The remote control system of claim 8, wherein the third format is a proprietary RF format.

10. The remote control system of claim 1, wherein the translator and the blaster are integrated into a single device.

11. The remote control system of claim 10, wherein the single device is a computer system.

12. The remote control system of claim 1, wherein the router and the translator are integrated into a single device.

13. The remote control system of claim 12, wherein the single device is a computer system.

14. The remote control system of claim 1, wherein the router, the translator, and the blaster are integrated into a single device.

15. The remote control system of claim 14, wherein the single device is a computer system.

16. The remote control system of claim 1, further comprising a computer system, which includes the translator, wherein the blaster is communicatively connected to the computer system via a bus.

17. The remote control system of claim 16, wherein the computer system is configured to be communicatively connected to a select one of the consumer-electronic devices for streaming media to the select consumer-electronic device.

18. The remote control system of claim 16, wherein the bus is a Universal Serial Bus (USB).

19. The remote control system of claim 1, wherein the translator and blaster are a single combined device, which includes:
a network interface controller to link the single combined device to the router via the network link;
a non volatile memory;
a control signal transmitter configured to transmit the packetized remote control codes in the set of second formats to the set of consumer-electronic devices; and
a microprocessor connected to the network interface controller to receive information from the first network and transmit information to the first network, the microprocessor also being connected to the non volatile memory and operable to store a representation of the state of the device in the non volatile memory, the microprocessor also being connected to the control signal transmitter to transmit the packetized remote control codes to the set of consumer-electronic devices and the microprocessor being responsive to information received from the first network to cause the control signal transmitter to transmit the packetized remote control codes to the set of consumer-electronic devices to alter the state of the set of consumer-electronic devices and the microprocessor being operable to update the stored representation of the state of the set of consumer-electronic devices to correspond with the altered state of the device.

20. A remote control system configured for controlling a set of consumer-electronic devices comprising:
a router configured to receive packetized remote control codes transmitted to the router in a first format;
a translator communicatively connected to the router via a network connection, wherein the translator is configured to receive the packetized remote control codes from the router in the first format and transmit the packetized remote control codes in a radio frequency (RF) broadcast in a second format; and
a blaster, wherein the blaster is configured to received the packetized remote control codes in the RF broadcast, extract the remote control codes from the packetized remote control codes, and transmit the remote control codes in IR to a set of consumer-electronic devices to control the set of consumer-electronic devices.

21. The remote control system of claim 20, further comprising a portable device configured to operate a remote control application for accepting a user selection for a set of actions for the set of consumer-electronic devices to execute.

22. The remote control system of claim 21, wherein the portable device is configured to transmit the packetized remote control codes to the router, and the remote control codes are configured to control the set of consumer-electronic devices to execute the set of actions.

23. The remote control system of claim 21, wherein the portable device is a smartphone, a laptop computer, or a netbook computer.

24. The remote control system of claim 21, wherein the portable device is configured to wirelessly transmit the packetized remote control codes to the router.

25. The remote control system of claim 20, wherein the translator is configured to translate the packetized remote control codes from the first format to the second format.

26. The remote control system of claim 25, wherein the first format is a network format and the second format is a radio frequency (RF) format.

27. The remote control system of claim 26, wherein the first format is a TCP/IP format.

28. The remote control system of claim 20, wherein the router is configured to receive the packetized remote control codes transmitted wirelessly to the router.

29. A combined translator-blaster device configured to control a set of consumer electronic devices comprising:
a network interface controller configured to receive packetized remote control codes from a router on a first network via a network link, wherein the packetize remote control codes are in a first format;
a non volatile memory;
a control signal transmitter configured to transmit the packetized remote control codes in the set of second formats to the set of consumer-electronic devices; and
a microprocessor connected to the network interface controller to receive information from the first network and transmit information to the first network, the microprocessor also being connected to the non volatile memory , the microprocessor also being connected to the control signal transmitter to transmit the packetized remote control codes to the set of consumer-electronic devices and the microprocessor being responsive to information received from the first network to cause the control signal transmitter to transmit the packetized remote control codes to the set of consumer-electronic devices to alter the state of the set of consumer-electronic devices.

30. The combined translator-blaster device of claim 29, wherein the non volatile memory is configured to store a representation of the state of the device in the non volatile memory, and wherein the microprocessor is further configured to update the stored representation of the state of the set of consumer-electronic devices to correspond with the altered state of the device.

31. The combined translator-blaster device of claim 29, further comprising a control signal receiver operable to receive control signals transmitted to alter the state of the set of consumer electronic devices, the microprocessor also being responsive to the control signals for the set of consumer electronic devices received by the control signal receiver to alter the stored representation of the state of the set of consumer-electronic devices to correspond to the altered state of the device.

32. The combined translator-blaster device of claim 29, wherein the microprocessor is further configured to provide discovery and description functions and information to the network as a proxy for the set of consumer-electronic devices.

33. The combined translator-blaster device of claim 29, wherein the microprocessor is further configured to reply to requests from the first network for information relating to the state of the set of consumer-electronic devices with the corresponding information in the stored representation of the state of the consumer-electronic devices.

34. The combined translator-blaster device of claim 29, further comprising at least one sensor configured to obtain data relevant to the operation of the set of consumer-electronic devices, wherein the microprocessor is further configured to provide the obtained data to the first network.

35. A remote control system configured for controlling a set of consumer-electronic devices comprising:
a first network, which includes a router configured to receive a first set of packetized remote control codes transmitted to the router in a first format from a first set of portable devices, wherein the first network is configured for communication via the first format;
a second network, which includes a second set of portable devices, wherein the second network is configured for communication via a second format, wherein each portable device in the second set of portable devices is configured to wirelessly communicate in the second format; and
a third network, which includes a combined translator-blaster device communicatively linked to the router via a network link and communicatively linked with the second set of portable devices, wherein the third network is configured for communication via the set of third formats,
wherein the combined translator-blaster device is configured to receive the first set of packetized remote control codes from the router in the first format and translate the first set of remote control codes from the first format to a set of third formats, and transmit the first set of packetized remote control codes in the set of third formats to a set of consumer-electronic devices to control the set of consumer-electronic devices, and
wherein the combined translator-blaster device is configured to receive a second set of packetized remote control codes from the second set of portable devices in the second format, translate the remote control codes from the second format to the set of third formats, and transmit the second set of packetized remote control codes in the set of third formats to the set of consumer-electronic devices to control the set of consumer-electronic devices.

36. The remote control system of claim 35, wherein the first format is a WiFi format, the second format is a proprietary format, and the set of third formats includes IR, USB, HDMI-CEC, and/or RF4CE.

37. The remote control system of claim 35, wherein each portable device in the first set of portable devices is configured to operate a remote control application for accepting a user selection for a set of actions for the set of consumer-electronic devices to execute and configured to transmit the first set of packetized remote control codes to the router in the first format, wherein the remote control codes are configured to control the set of consumer-electronic devices to execute the set of actions.

38. The remote control system of claim 37, wherein the first set of portable devices includes a smartphone, a laptop computer, and a netbook computer.

39. The remote control system of claim 35, wherein the combined translator-blaster device is a computer system.

40. The remote control system of claim 35, wherein each portable device in the second set of portable devices is configured to operate a remote control application for accepting a user selection for a set of actions for the set of consumer-electronic devices to execute and configured to transmit the second set of packetized remote control codes to the combined transceiver-blaster device in the second format, wherein the second set of packetized remote control codes are configured to control the set of consumer-electronic devices to execute the set of actions.

41. The remote control system of claim 40, wherein the second set of portable devices includes a keyboard, a remote control, and a computer system.
